(19) United States
(12) Patent Application Publication
(10) Pub. No.: US 2025/0039007 A1
(43) Pub. Date: Jan. 30, 2025

(54) WEB CONFERENCING WITH CONVERSATION GROUPS

(71) Applicant: International Business Machines Corporation, Armonk, NY (US)

(72) Inventors: Angelo Danducci, II, Austin, TX (US); Mohamad O. Mohamad, Houston, TX (US); Ting Pan, Hutto, TX (US); Emanuel Vargas, Austin, TX (US)

(21) Appl. No.: 18/358,336

(22) Filed: Jul. 25, 2023

(51) Int. Cl. H04L 12/18; G10L 15/18

(52) U.S. Cl. CPC H04L 12/1822; G10L 15/1815; H04L 12/1831

(57) ABSTRACT

Web conferencing is enhanced with conversation groups having individual group volume controls. Multiple conversations are perceived by participants, the conversations having varied microphone volume levels that allows a participant to engage in one conversation group while, at the same time, listening in on other simultaneous conversations having a relatively lower volume setting. A user interface provides for user-selection of conversation groups in which to participate. Group conversations are established according to conditional rules related to number of participants and time lapse between mentions of a particular topic and/or multiple comments by a one participant responsive to another participant.

### BACKGROUND

The present invention relates generally to the field of web conferencing, and more particularly to multi-topic social gatherings in a web conference environment.

Web conferencing refers to various types of online conferencing and collaborative services such as internet-based seminars, broadcasts, online meetings. In general, web conferencing is made possible by Internet technologies, particularly on TCP/IP connections. Web conferencing services allow for real-time point-to-point communications by offering data streams of voice and video chat to be shared simultaneously across geographically dispersed locations. Applications for web conferencing include meetings, training events, and lectures from one internet-connected computer to another.

Sound pressure or acoustic pressure is the local pressure deviation from the ambient (average or equilibrium) atmospheric pressure caused by a sound wave. Sound pressure can be measured using a microphone. In acoustics, loudness is the subjective perception of sound pressure. A microphone is a transducer that converts sound into an electrical signal. Several types of microphones are used today, which employ different methods to convert the air pressure variations of a sound wave to an electrical signal. The European Broadcasting Union (EBU) adopted the standard EBU R 128, which is a recommendation for loudness normalisation and maximum level of audio signals. It is primarily followed during audio mixing of television and radio programs and adopted by broadcasters to measure and control program loudness

Latent dirichlet allocation (LDA) is a generative statistical model that explains a set of observations through unobserved groups, and each group explains why some parts of the data are similar. The LDA is an example of a topic model in natural language processing. Observations (e.g., words) are collected into text documents and presence of the observation is attributable to one of the topics of the document where each document contains a small number of topics.

### SUMMARY

In one aspect of the present invention, a method, a computer program product, and a system includes: identifying a first set of participants in a web meeting, the first set of participants speaking about a first topic; establishing a first conversation group associated with the first topic including the first set of participants; identifying a second set of participants in the web meeting, the second set of participants speaking about a second topic; establishing a second conversation group associated with the second topic including the second set of participants, the second conversation group audibly connected to the first conversation group and the first conversation group audibly connected to the second conversation group; and, for members of the first conversation group, setting a second group volume of members of the second conversation group lower than a first group volume of members of the first conversation group.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system; and

FIG. 4 is a screenshot view generated by the first embodiment system.

### DETAILED DESCRIPTION

Web conferencing is enhanced with conversation groups having individual group volume controls. Multiple conversations are perceived by participants, the conversations having varied microphone volume levels that allows a participant to engage in one conversation group while, at the same time, listening in on other simultaneous conversations having a relatively lower volume setting. A user interface provides for user-selection of conversation groups in which to participate. Group conversations are established according to conditional rules related to number of participants and time lapse between mentions of a particular topic and/or multiple comments by a one participant responsive to another participant.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as conversations program 300. In addition to block 300, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 300, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

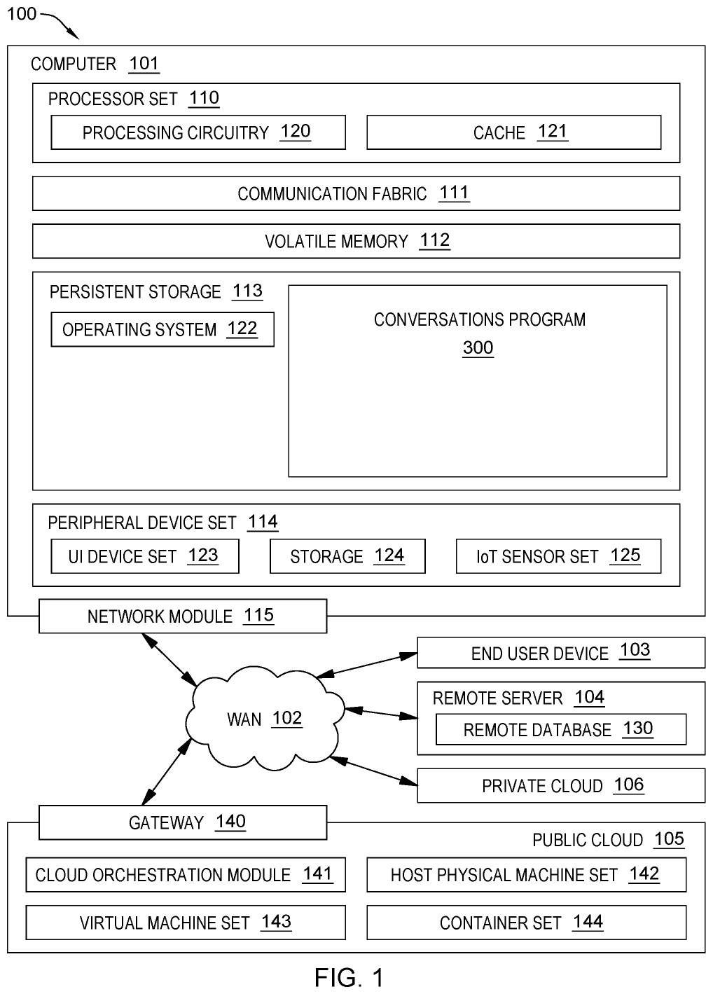

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 300 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 300 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Conversations program 300 operates to selectively establish volume levels for topic-based groups during a web conference. Spoken language during a web conference is parsed for topics, which drive establishment of conversation groups. Participants in a given conversation group receive microphone audio at a relatively higher volume than audio transmitted by non-group participants. Further, the conversations program presents participants with an interface for changing the conversation group in which they are participating.

Some embodiments of the present invention build upon the notion that when participants are in a social event, the sounds they hear have varying sound pressure levels due to distance from where the sound originates. Despite the sound level varying by distance, some lower volume sounds, such as one's name, may catch their attention, even at a greater distance than other spoken words.

To simulate overhearing other conversations during an in-person meeting as discussed above, some embodiments of the present invention use varying audio levels and/or visual representations of conversation groups and their corresponding topics.

Some embodiments of the present invention recognize the following facts, potential problems and/or potential areas for improvement with respect to the current state of the art: (i) in conventional web conference, communications are managed as one to many, such as one speaker to everyone else who remain relatively quiet, or even muted, when the web conference begins; (ii) despite the rise in popularity of using web conferencing technology for communications, group discussions during a web conference often fall short when compared to in-person discussions; and (iii) in-person conferences allow for people to speak among themselves while attending the same meeting in one physical space.

According to some embodiments of the present invention, a conversation is an oral, spoken language event that may occur among participants of an in-person conference or meeting. Conversations of occur after a participant, or speaker, presents a subject or topic of discussion. Conversations begin when multiple participants orally discuss a subject, or topic, among themselves following introduction of a principal topic by a speaker, or participant. When the topic being discussed varies from the principal topic, participants may distance themselves from the other participants while remaining within hearing distance of the other participants.

According to some embodiments of the present invention, when a conversation is established among two or more participants via web-conferencing technology, the relative volume of non-conversation participants within the web conference is adjusted down for conversation participants so they can better focus on their conversation while still hearing web conference participants discussing other topics.

Some embodiments of the present invention are directed toward detecting a topic of an initial conversation in a web conference. Oftentimes, the topic of initial conversation matches the subject matter for which the meeting is being held. Alternatively, a primary topic is designated by a meeting organizer or a subject line of a corresponding meeting invitation.

Some embodiments of the present invention are directed to adding topics and corresponding conversation groups in a web conference environment. For example, as additional participants speak during the web conference, a conversation topic may be identified. When the spoken topic matches the topic of current conversation group in which the participant is a member, no change is made. However, when a new topic is determined based on the spoken language of a participant, the topic is recorded with a timestamp and participant identifier. When another participant speaks on the newly recorded topic within a predefined time period, another timestamp and participant ID are associated with the new topic. In this example, when the original participant who introduced the new topic speaks again on the same new topic, the system establishes a new conversation group associated with the new topic. The new conversation group is assigned a standard group microphone volume and microphones of non-participants of the new conversation group are reduced relative to the volume of the participants according to a default simulated distance from other conversation groups. Alternatively, one or both participants are provided reduced relative volumes of other conversation groups according to participant-specified interests recorded in the user profile of the individual participant. Alternatively, after setting the default simulated distances, a user interface is provided to each participant to adjust relative microphone volumes of participants according to their membership in conversation groups.

Some embodiments of the present invention simulate distance based on conversation group membership using relative microphone volume and a distancing scheme among conversation groups established in a web conference. For a given set of participants forming a conversation group, the microphone volume is standardized to a specific level. Audio loudness normalization may be based on the EBU R 128 loudness standard. For example, when a conversation group is established, all members of the conversation group would have the standard web meeting volume after normalization of participant microphone volumes are set. When there are multiple conversation groups occurring simultaneously, each group would have their own standard meeting volume set within the conversation group in which they are participating.

In addition to having conversation participants set at a standard volume, each included participant of the web conference is also able to hear other web meeting attendees speaking outside of their conversation group at relatively reduced volumes with respect to the standard volume setting for conversation group participants. For example, the microphone volume of web meeting attendees outside of a conversation group is reduced to a sub-standard volume. If the standard volume for within the conversation group were 100%, other web conference attendees may be heard at 20% volume, based on a specified simulation distance from the conversation group. When there are multiple conversation groups in the web conference, the reduced volume will vary according to simulated distances such that a nearest conversation group may be 40%, another, more distant group may be at 20%, while the furthest away may be set at 10% of the standard volume.

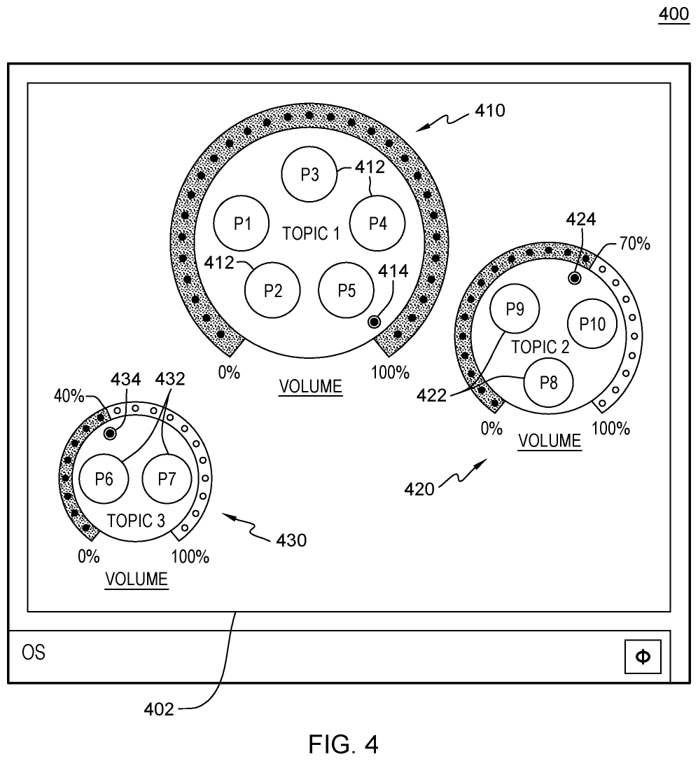

Some embodiments of the present invention are directed to displaying a user-selectable interface representing the web conference and the various established conversation groups. In this example, conversation groups are represented in two-dimensional space with distances between conversation groups shown according to relative microphone volume of the various conversation groups (See FIG. 4). According to some embodiments of the present invention, conversation groups are represented according to individual participant settings for simulated distances from one other conversation groups. The individual participant settings may reflect a default setting established by the conversations program or may reflect revised settings input by the individual participant. Additionally, conversation topics may be displayed to identify the established topic of a conversation group. Alternatively, the conversation groups are represented in a three-dimension space that may represent a selected conference center with conversation groups distributed within the three-dimensional space of the conference center according to relative microphone volume of the various conversation groups.

Some embodiments of the present invention are directed to providing individual adjustment of simulated distances from other conversation groups. In that way, participants in the web conference may effectively listen in on selected conversations by causing the microphones of participants in other conversation groups to be relatively higher than other conversation groups. Further, users may be presented with an interface for selecting other conversations groups to join. Upon selecting a different conversation group, the participant will notice a change in microphone settings among the conversation groups with the selected different conversation group having a standard volume setting and other conversation groups having a relatively lower microphone setting according to simulated distances or according to an assigned percentage of the standard volume setting.

Some embodiments of the present invention are directed to monitoring the conversation groups for activity and closing inactive conversation groups and/or to removing participating members of a conversation group and/or changing membership of participants from one conversation group to another conversation group. For example, a time-based approach may be used in which a specified duration of time in which there is silence in a conversation group triggers a designation of inactive for the conversation group and the system automatically closes the inactive conversation group. Alternatively, a specified percentage of participants may designate the conversation group as inactive, triggering an automatic closure of the inactive conversation group. The specified percentage may be received from the web conference organizer or may be set by established policy of the web conference host. Alternatively, a conversation group having only one participant triggers the designation of the conversation group as inactive.

Additionally, when an inactive conversation group is closed, remaining participants may be transferred to other active conversation groups. According to some embodiments of the present invention, remaining participants are automatically assigned to rejoin their most recent conversation group among active conversation groups. Alternatively, when the web conference has an assigned meeting topic, remaining participants are assigned to join the conversation group for the meeting topic. Alternatively, when the web conference has a principal speaker, remaining participants are assigned to join the conversation group that includes the principal speaker.

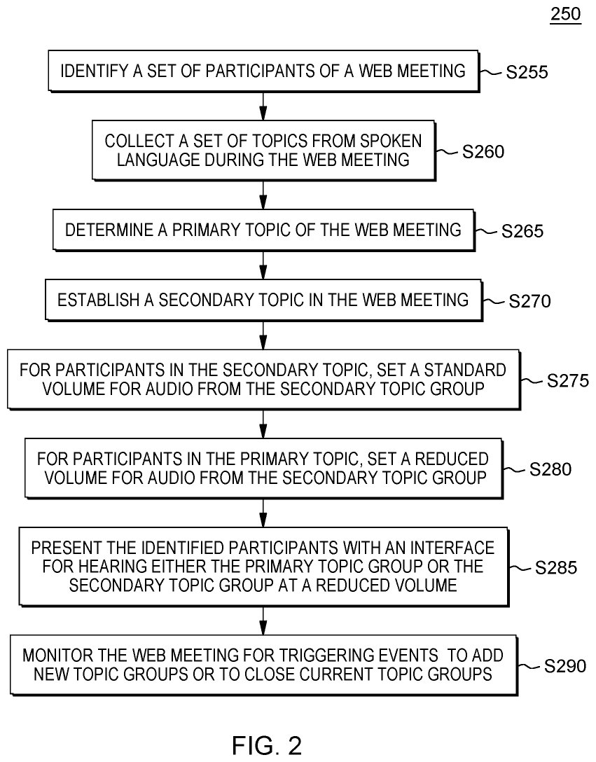

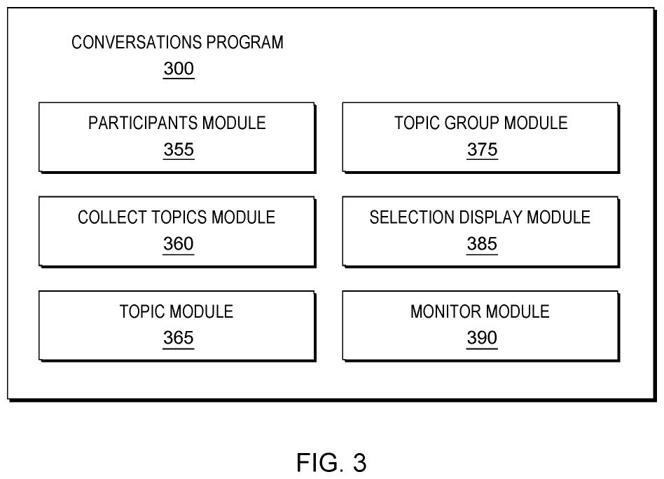

FIG. 2 shows flowchart 250 depicting a first method according to the present invention. FIG. 3 shows conversations program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where participants module (“mod”) 355 identifies a set of participants of a web conference, or web meeting. In this example, all members of a web meeting are identified as participants and make up the set of participants. Alternatively, only some of the members of the web conference are participants in the conversations program. Participants may be identified according to a registered user profile or a list of subscribers. Identified participants are able to participate conversation groups during the web meeting and may hear non-participants as a single conversation group or at a lower relative volume than any other conversation groups in the meeting.

Processing proceeds to step S260, where collect topics mod 360 collects a set of topics from spoke language during the online meeting, or web conference. Topics are identified by processing spoken language during the meeting by use of, for example, keywords. Alternatively, natural language processing is applied to the spoke language to identify topics. Some embodiments of the present invention apply latent dirichlet allocation (LDA) to identify topic(s) discussed in the meeting such that spoke words are converted to text strings from which topics are identified. collection of topics may include recording triples (such as participant identification, topic, timestamp) to a structure database. The collection of topics and topic data support determining primary and secondary topics for topic group generation, as discussed below.

Processing proceeds to step S265, where topic mod 365 determines a primary topic of the web meeting. In this example, a primary topic is based on a meeting agenda with respect to a schedule of topics and a primary conversation group is established according to the schedule of topics. When a scheduled topic is due to be discussed, the primary meeting topic is the scheduled topic. Alternatively, a primary topic is the first identified topic meeting a threshold level of participation to form a conversation group. For example, if the threshold level of participation is two replies, when the same topic is mentioned three times including two replies within a specified period of time after the start of the web meeting, the topic is established as a primary topic. Further in this example, the primary topic is the default topic for all participants in the web meeting.

Processing proceeds to step S270, where topic mod 370 determines a secondary topic in the web meeting. As topic data continues to be collected according to operation S260, secondary topics may be identified within the ongoing set of topics. Each time a subsequent topic meets the specified threshold level of participation, a secondary topic is established for a new conversation group. In this example, secondary topics are dynamic in that they are subject to being created and closed based on participation.

Processing proceeds to step S275, where topic group mod 375 sets a standard volume in the secondary topic group for microphone audio from participants in the secondary topic group. The secondary topic group includes individual participants who meet a threshold level of involvement in the secondary topic or have otherwise indicated an interest in the secondary topic.

Processing proceeds to step S280, where topic group mod 375 sets a reduced volume in the primary topic group for microphone audio from participants in the secondary topic group. The reduced volume being relative to the microphone volume from participants in the primary topic group. The primary topic group includes individual participants who meet a threshold level of involvement in the primary topic or have otherwise indicated an interest in the secondary topic.

Processing proceeds to step S285, where selection display mod 385 presents the identified participants with an interface for hearing the primary topic group or the secondary topic group at the reduced speaker volume. In this example, a user interface as shown in FIG. 4 illustrates a two-dimensional representation of a principal topic group 410 and various other topic groups 420 and 430 in the web conference. The groups include selectable volume interfaces 414, 424, 434 to adjust the microphone volume of the various topic groups. In this example, the volume is adjusted by dragging the indicator along the path from 0% volume to 100% volume. As shown in FIG. 4, the volume for the principal topic group is 100%, while the volumes for other groups 420 and 430 are 70% and 40%, respectively. The principal topic group is the topic group of the participant for whom the user interface is generated. In this example, the size of the topic groups is illustrated by the relative size of each group image and the simulated distance by reduced relative volume is illustrated by two-dimensional distance from the primary topic group. It should be noted that FIG. 4 illustrated the user interface as presented to a member of the principal topic group. Where members of a given topic group have the relative volume set to 100% for their principle topic group, members would view a display from their perspective with 100% volume for their topic group and relative reduction in volume and corresponding distance from the other topic groups in the web conference.

Processing ends at step S290, where monitor mod 390 monitors the web meeting for triggering events to add new topic groups and to close current topic groups. Throughout the duration of the web conference, collect topics mod 360 identifies and collects topics from the spoken language. Using pre-defined threshold values for triggering the establishment of topic groups,

Further embodiments of the present invention are discussed in the paragraphs that follow and later with reference to FIG. 4.

Some embodiments of the present invention are directed to allowing conversations to happen among a sub-set of participants in an online spoken-language meeting. For example, during an in-person meeting in an auditorium or at a conference center, small group conversations often occur and are often encouraged to occur, particularly during networking events. Participants of the in-person meeting who join the small group conversations are readily able to switch conversations and mingle. Some embodiments of the present invention use selective audio levels and topic-driven groupings to allow virtual participants to enjoy a similar experience during an online meeting by monitoring audio content for topics and dynamically assigning conversation groups during portions of an online meeting. Further, participants may move from one conversation to another conversation according to a specified topic of each conversation.

Some embodiments of the present invention are directed to determining a topic of conversation by speech to text conversion. The resulting text may use latent dirichlet allocation (LDA) to identify topic(s) discussed in the meeting. According to some embodiments of the present invention, speech to text and LDA are used to identify an initial topic of the meeting and to collected topic data during the web conference. A topic list may be generated by monitoring conversations in the conference as separate speech to text streams.

According to some embodiments of the present invention, when first creating a new conversation, there is an opportunity for a selected participant to opt out of the conversation group. When there is only one participant in a given conversation group, the group is closed, and the remaining participant or participants are placed in an existing conversation group. Further, membership in the new conversation group is made available to participants of the web conference by an updated user interface indicating the new topic as being available.

Some embodiments of the present invention calculate sound attenuation according to the inverse square law such that a point source emits a sound wave uniformly in all directions (essentially spherically). The intensity of the sound wave energy at any given point away from the source is diminished as a function of the total surface area of the sphere coincident with that point. Accordingly, separate conversation groups can be simulated to be at differing distances away from other conversation groups where there is a normal default simulation of distance, such as 6-10 feet. For example, there may be only two conversation groups set by default at the opposite ends of a 10 foot meeting room.

Some embodiments of the present invention provide for each user to establish which conversation groups are closer than others. In that way, an identified participant in the web conference, can set additional conversations to be at any chosen distance, whether simulated closer or further away than default settings. According to some embodiments of the present invention, a limit to the number of conversation groups is not required because any number of additional conversations can be managed even if they were equal distances from a given conversation group, which naturally occurs in larger group settings. For smaller web conferences, each of three or four conversation groups could be simulated at different distances away from each other.

Some embodiments of the present invention adjust simulated distance of a participant from other conversation groups based on a participant profile. The participant profile may indicate topics of interest. Where a first conversation group is associated with a first topic and a second conversation group is associated with a second topic and the participant profile lists the second topic as a topic of interest, the simulated distance from the participant to the second conversation group would be closer than that of the first conversation groups.

Some embodiments of the present invention are directed to adding new participants to the web conference while conversation groups are active. In this example, newly added participants automatically join as participants of the conversation group having the most members or, if there is more than one having the most members, the most recently established conversation group with the most members. Alternatively, a representation of the conversation groups such as the one shown in FIG. 4 is presented to the newly added participant for selection of a conversation group to join. Alternatively, other aspects of the various conversation groups may be the basis for automatically adding new participants to existing conversation groups. For example, the user profile of the new added participant may indicate topics of interest and the newly added participant may be automatically joined to a conversation group based on a matching topic of interest.

Some embodiments of the present invention are directed to a process including: establishing conversation groups based on an initial topic and subsequent replies to the same topic; simulating distance among meeting participants using dynamic volume adjustment according to topic-based conversations occurring within a web meeting; simulating distance among meeting participants using visual representations of established conversation groups within a web meeting; switching between a current conversation group and another conversation group during an online meeting; and removing a user from all conversations during an online meeting to, for example, allow the user to listen to a current speaker or to view a current presentation.

Some embodiments of the present invention are direct to visually representing the topics of each ongoing conversation during a web meeting.

Some embodiments of the present invention are directed to adjusting the relative microphone volume for participants in one conversation group with respect to the microphone volume of participants in other conversation groups. The volume may be adjusted according to a topic spoken by a speaking participant of a web conference. By grouping participants according to topics being discussed, one conversation group and another conversation group may have the same relative volume for participants within their assigned group and the same reduced volume for participants of the other group while all are attending the same online audio or video conference.

Some embodiments of the present invention apply LDA (Latent Dirichlet Allocation) to support presentation of a topic list to each participant. In that way, participants may jump between different conversation groups based on the corresponding topic being discussed.

Some embodiments of the present invention are directed to creating additional conversation groups within a single online meeting. In some embodiments, each conversation group has a designated relative volume level. Further, some embodiments of the present invention are directed to dissolving old conversations upon detecting a threshold participation level or upon determining that all participants in the conversation group have joined other conversation groups or are listening to a current speaker/presenter.

Some embodiments of the present invention do not require each participant be placed in a location in virtual space because the virtual space can be adjusted according to the number of topics and/or specified “distance” between conversation groups, where the “distance” is simulated by the amount of reduction in volume below the volume of a current conversation group.

Some embodiments of the present invention are directed to the in-person meeting characteristic of participants being able to hear words spoken at a distance in a lower volume. For example, during an in-person meeting, two people may be talking about a recently played game while the rest of the group is talking about a work-related subject. Participants in each of these groups are listening to their own conversation, but they can be distracted by an audible conversations nearby and someone may want to join the other, more distant conversation. In a similar way as when one hears their name mentioned in a crowded room, participants of an online-based meeting may also be able to hear certain words mentioned in other conversation groups and, responsive to hearing the word, turn their attention to that conversation group.

Some embodiments of the present invention determine a topic of conversation during an online meeting and relevant chatter among participants of the meeting. Further, volume levels of selected participants are dynamically adjusted according to the topic of conversation.

Some embodiments of the present invention are directed to more than identifying the conversations/topics being discussed in real-time via a natural language processing (NLP) engine in the video conferencing service and more than labeling and displaying the topics identified by NLP with continuous updating.

Some embodiments of the present invention are directed to more than a method for configuring filter settings of a conversation manager (e.g., volume adjustments and fine-tuned accessing permission controls) as participants in a meeting room initiate multiple simultaneous conversations without opening a new meeting or breakout room.

Some embodiments of the present invention are directed to more than a method for adjusting the volume on the audio feeds such that each participant clearly hears (at a normal volume) other participants in a primary conversation and in other conversations at a much lower (background) volume providing for a uniform background noise filter.

Some embodiments of the present invention are directed to more than a method for providing an action manager that initiates actions on behalf of participants based on the content of the conversation (e.g., displaying a visual confirmation of an answer of a participant instead of requiring the participant to speak) and more than a method for identifying a current conversational topic based on an initial topic and a reply to the same topic in the online meeting.

Some embodiments of the present invention are directed to simulating distance based on one or more conversations occurring within a web meeting based on dynamic volume adjustment and/or visual representation utilizing conversations.

Some embodiments of the present invention are directed to switching between a local conversation group and another conversation group and/or removing a participant in a web conference from all conversation groups responsive to a keynote speaker or other presenter beginning to speak. According to some embodiments of the present invention, the removing users from all conversation groups is performed according to a calendar of events indicating the beginning of a presentation.

FIG. 4 depicts display screen 400 with user interface 402 including topic group elements 410, 420, and 430. The illustrated topic groups include an audio selection tool 414, 424, and 434 and a representation of the participants 412 in each topic group with principal topic group 410 including five participants 412, specifically participants P1, P2, P3, P4, and P5. The principal topic is “Topic 1,” which is centrally located in the group's display 410. Topic group 420 includes three participants 422, specifically participants P8, P9, and P10, with the topic being “Topic 2.” Topic group 430 includes two participants 432, specifically participants P6 and P7, with the topic being “Topic 3.”

An example process according to some embodiments of the present invention is where a web conference is held while watching a sporting event with seven participants. As the web conference begins, a first participant comments on a play on the field and two others reply by discussing aspects of the play. Because of the interaction among the three participants, a threshold is met for forming an initial topic group for the play on the field. During the discussion, a fourth user talks about a player in the game and a fifth participant replies. Where the triggering event is a first reply on the same topic, the two users talking about the player are asked via a prompt on the screen if they want to start a new topic group about the player. The two players accept the proposal and begin a separate topic group. A conversation display presents participants 1, 2, 3, 6, and 7 in one topic group “play on the field” and participants 4 and 5 are in another topic group “player.” The relative volume within each group is 100% and the relative volume outside each group is 60%, allowing users to hear what the other group is discussing in case they want to interact verbally with the other group.

Some embodiments of the present invention may include one, or more, of the following features, characteristics and/or advantages: (i) multiple oral conversations can occur at the same time in a coherent manner during a single web conference, or online meeting, such that each conversation participant experiences an uninterrupted conversation with other participants; (ii) maintains a feeling of physical movement within a space in a web meeting based on topic membership; (iii) facilitates discovery of conversation topics during a web meeting without requiring the user to listen to each conversation in the meeting; (iv) universally applicable to any web meeting or online conference or video call without changing the virtual representation of the meeting; (v) facilitates movement of individual participants between conversation groups; (vi) facilitates adjustment of the relative volume of different conversation groups; (vii) provides for participants in one conversation group to be a selected “distance” from each other conversation group in the meeting by simulating the distance with audio volume levels assigned to the current conversation groups; (viii) provides for the ability to hear key words at lower volume from another conversations; and (ix) participants in a sub-group of an online meeting are able to communicate using spoken language with each other while maintaining awareness of outside context or unrelated spoken-language conversations occurring during the same online meeting.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
identifying a first set of participants in a web meeting, the first set of participants speaking about a first topic;
establishing a first conversation group associated with the first topic including the first set of participants;
identifying a second set of participants in the web meeting, the second set of participants speaking about a second topic;
establishing a second conversation group associated with the second topic including the second set of participants, the second conversation group audibly connected to the first conversation group and the first conversation group audibly connected to the second conversation group; and
for members of the first conversation group, setting a second group volume of members of the second conversation group lower than a first group volume of members of the first conversation group.

2. The computer-implemented method of claim 1, further comprising:
monitoring spoken language by participants in the web meeting to identify the first topic, the participants including the first and second sets of participants;
recording the first topic to a database including topic name, participant identification, and timestamp.

3. The computer-implemented method of claim 1, wherein the second group volume is representative of a designated distance between the first set of participants and the second set of participants according to a calculated sound pressure.

4. The computer-implemented method of claim 1, further comprising:
presenting a user interface to the first set of participants for selecting a reduced group volume associated with the second group volume, the second group volume being microphone volumes, as received by the first set of participants, of the second set of participants.

5. The computer-implemented method of claim 1, further comprising:
monitoring audio in the second conversation group; and
responsive to the second topic not being discussed for a specified period of time, closing the second conversation group, and reassigning the second set of participants to other conversation groups in the web meeting.

6. The computer-implemented method of claim 5, wherein reassigning the second set of participants includes:
matching a topic of interest of a participant in the second set of participants with a third topic associated with a third conversation group.

7. The computer-implemented method of claim 1, further comprising:
monitoring spoken language in the web meeting for candidate topics;
determining a candidate topic satisfies a group threshold; and
establishing a fourth conversation group associated with the candidate topic, the fourth conversation group including a fourth set of participants discussing the candidate topic in the web meeting.

8. A computer program product comprising a computer-readable storage medium having a set of instructions stored therein which, when executed by a processor, causes the processor to perform a method comprising:
identifying a first set of participants in a web meeting, the first set of participants speaking about a first topic;
establishing a first conversation group associated with the first topic including the first set of participants;
identifying a second set of participants in the web meeting, the second set of participants speaking about a second topic;
establishing a second conversation group associated with the second topic including the second set of participants, the second conversation group audibly connected to the first conversation group and the first conversation group audibly connected to the second conversation group; and
for members of the first conversation group, setting a second group volume of members of the second conversation group lower than a first group volume of members of the first conversation group.

9. The computer program product of claim 8, the set of instructions further causing the processor to perform a method comprising:
monitoring spoken language by participants in the web meeting to identify the first topic, the participants including the first and second sets of participants; and
recording the first topic to a database including topic name, participant identification, and timestamp.

10. The computer program product of claim 8, wherein the second group volume is representative of a designated distance between the first set of participants and the second set of participants according to a calculated sound pressure.

11. The computer program product of claim 8, the set of instructions further causing the processor to perform a method comprising:
presenting a user interface to the first set of participants for selecting a reduced group volume associated with the second group volume, the second group volume being microphone volumes, as received by the first set of participants, of the second set of participants.

12. The computer program product of claim 8, the set of instructions further causing the processor to perform a method comprising:
monitoring audio in the second conversation group; and
responsive to the second topic not being discussed for a specified period of time, closing the second conversation group, and reassigning the second set of participants to other conversation groups in the web meeting.

13. The computer program product of claim 8, the set of instructions further causing the processor to perform a method comprising:
monitoring spoken language in the web meeting for candidate topics;
determining a candidate topic satisfies a group threshold; and
establishing a fourth conversation group associated with the candidate topic, the fourth conversation group including a fourth set of participants discussing the candidate topic in the web meeting.

14. A computer system for comprising:
a processor set; and
a computer readable storage medium having program instructions stored therein;
wherein:
the processor set executes the program instructions that cause the processor set to perform a method comprising:
identifying a first set of participants in a web meeting, the first set of participants speaking about a first topic;
establishing a first conversation group associated with the first topic including the first set of participants;
identifying a second set of participants in the web meeting, the second set of participants speaking about a second topic;
establishing a second conversation group associated with the second topic including the second set of participants, the second conversation group audibly connected to the first conversation group and the first conversation group audibly connected to the second conversation group; and
for members of the first conversation group, setting a second group volume of members of the second conversation group lower than a first group volume of members of the first conversation group.

15. The computer system of claim 14, the program instructions further causing the processor set to perform a method comprising:
monitoring spoken language by participants in the web meeting to identify the first topic, the participants including the first and second sets of participants; and
recording the first topic to a database including topic name, participant identification, and timestamp.

16. The computer system of claim 14, wherein the second group volume is representative of a designated distance between the first set of participants and the second set of participants according to a calculated sound pressure.

17. The computer system of claim 14, the program instructions further causing the processor set to perform a method comprising:
presenting a user interface to the first set of participants for selecting a reduced group volume associated with the second group volume, the second group volume being microphone volumes, as received by the first set of participants, of the second set of participants.

18. The computer system of claim 14, the program instructions further causing the processor set to perform a method comprising:
monitoring audio in the second conversation group; and
responsive to the second topic not being discussed for a specified period of time, closing the second conversation group, and reassigning the second set of participants to other conversation groups in the web meeting.

19. The computer system of claim 18, wherein reassigning the second set of participants includes:
matching a topic of interest of a participant in the second set of participants with a third topic associated with a third conversation group.

20. The computer system of claim 14, the program instructions further causing the processor set to perform a method comprising:
monitoring spoken language in the web meeting for candidate topics;
determining a candidate topic satisfies a group threshold; and
establishing a fourth conversation group associated with the candidate topic, the fourth conversation group including a fourth set of participants discussing the candidate topic in the web meeting.
